(19) United States
(12) Patent Application Publication
(10) Pub. No.: US 2023/0340213 A1
(43) Pub. Date: Oct. 26, 2023

(54) FIBER-REINFORCED RESIN SHEET, FIBER-REINFORCED COMPOSITE MATERIAL, AND MOLDED ARTICLE

(71) Applicant: FUKUVI CHEMICAL INDUSTRY CO., LTD., Fukui (JP)

(72) Inventor: Naoaki KANAMORI, Fukui (JP)

(73) Assignee: FUKUVI CHEMICAL INDUSTRY CO., LTD., Fukui (JP)

(21) Appl. No.: 18/025,721

(22) PCT Filed: Nov. 29, 2021
(86) PCT No.: PCT/JP2021/043554

§ 371 Date: Mar. 10, 2023

(30) Foreign Application Priority Data
Dec. 28, 2020 (JP) 2020-218665

(51) Int. Cl. C08J 5/04

(52) U.S. Cl. CPC C08J 5/042; C08J 2377/10; C08J 2300/22

(57) ABSTRACT

A fiber-reinforced resin sheet includes a resin film which is thermoplastic, and a plurality of reinforcing fibers that are placed on the opposite surfaces of the resin film in a state of being oriented in the same direction after being opened from a bundle of reinforcing fibers. The resin film has a thickness of 5 μm or more and 15 μm or less, an areal weight of the reinforcing fibers is 25 g/m² or more and 60 g/m² or less, and a volume content of the reinforcing fibers is 60% or more and 75% or less. The fiber-reinforced resin sheet has a thickness of 30 μm or more and 65 μm or less.

### TECHNICAL FIELD

The present invention relates to a fiber-reinforced resin sheet containing a resin film and reinforcing fibers, a fiber-reinforced composite material made by forming the fiber-reinforced resin sheet, and a molded article made by molding the fiber-reinforced composite material.

### BACKGROUND ART

As an exemplary fiber-reinforced resin sheet, the following one disclosed in Patent Literature 1 is known. The fiber-reinforced resin sheet (thermoplastic carbon fiber prepreg) of Patent Literature 1 contains opened carbon fibers in the shape of a sheet, and a pair of thermoplastic resin films placed on the opposite surfaces (on one surface and the other surface) of the carbon fibers. The fiber-reinforced resin sheet having the structure is produced by sandwiching the carbon fibers between the pair of resin films, and pressing and heating the same. Specifically, for the fiber-reinforced resin sheet of Patent Literature 1, there are a step of supplying carbon fibers, while being opened, through supply rollers, and a step of placing the thermoplastic resin films on the opposite surfaces of the supplied carbon fibers, and thereafter, heating the resin films by plate heaters while sandwiching the resin films by the rollers. This enables the resin films to be softened and permeate into the carbon fibers, whereby a fiber-reinforced resin sheet having the structure described above is obtainable.

Patent Literature 1 mentions that the thickness of the resin films is desirably set between 8 and 55 μm. The reason is that the volume content (Vf value) of the carbon fibers in the fiber-reinforced resin sheet can be increased to 50 to 60%, whereby a high strength is achievable.

However, in Patent Literature 1, since the resin films are respectively arranged on the opposite surfaces of the carbon fibers (the carbon fibers are sandwiched between a pair of resin films), the ratio of the resin is inevitably liable to be high. In other words, if an attempt is actually made to increase the content of the carbon fibers in Patent Literature 1 to reach 50 to 60%, there will be the need to place a great amount of carbon fibers between the pair of resin films. Therefore, even if the resin films are pressed and heated during preparation, the softened resin films are still liable to fail to sufficiently permeate the inside of the carbon fibers. When the permeation of the resin films is insufficient, a failure such as the loosening of carbon fibers after the preparation is liable to occur.

### CITATION LIST

### Patent Literature

Patent Literature 1: Japanese Unexamined Patent Publication No. 2020-122137

### SUMMARY OF INVENTION

The present invention has been made in view of the circumstances described above, and an object thereof is to provide a fiber-reinforced resin sheet which has a high content of reinforcing fibers and has a reduced formation failure, thereby improving the mechanical properties of a fiber-reinforced composite material or a molded article thereof.

A fiber-reinforced resin sheet according to an aspect of the present invention, which has solved the problem described above, has a thickness of 30 μm or more and 65 μm or less, and includes a resin film which is thermoplastic; and a plurality of reinforcing fibers that are placed on the opposite surfaces of the resin film in a state of being oriented in the same direction after being opened from a bundle of reinforcing fibers, wherein the resin film has a thickness of 5 μm or more and 15 μm or less, an areal weight of the reinforcing fibers is 25 g/m² or more and 60 g/m² or less, and a volume content of the reinforcing fibers is 60% or more and 75% or less.

### BRIEF DESCRIPTION OF DRAWINGS

FIG. 1 is a flowchart showing a method for producing a molded article according to a first embodiment of the present invention.

FIG. 2 is a diagram showing a schematic configuration of an apparatus for producing a fiber-reinforced resin sheet.

FIG. 3 is a diagram illustrating a method for forming a fiber-reinforced composite material by stacking fiber-reinforced resin sheets.

FIG. 4A is a cross-sectional view illustrating a method for molding a molded article from the fiber-reinforced composite material using a heat press machine.

FIG. 4B is a cross-sectional view showing a state of the heat press machine during molding.

FIG. 4C is a cross-sectional view showing a state of the heat press machine at the completion of the molding.

FIG. 5 is a flowchart showing a method for producing a molded article according to a second embodiment of the present invention.

FIG. 6 is a diagram illustrating a method for cutting off a chopped piece from a fiber-reinforced resin sheet.

FIG. 7 is a diagram illustrating a method for forming a fiber-reinforced composite material by accumulating chopped pieces.

FIG. 8 is a table showing properties of fiber-reinforced resin sheets of Examples.

FIG. 9 is a table showing properties of fiber-reinforced resin sheets of Comparative Examples.

FIG. 10 is a table showing properties of fiber-reinforced composite materials of Examples and Comparative Examples.

### DESCRIPTION OF EMBODIMENTS

Hereinafter, preferred embodiments of the present invention will be described with reference to the drawings.

### (1) First Embodiment

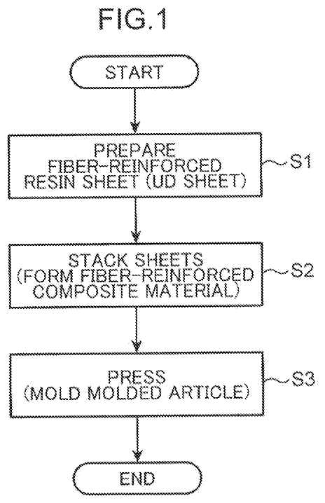

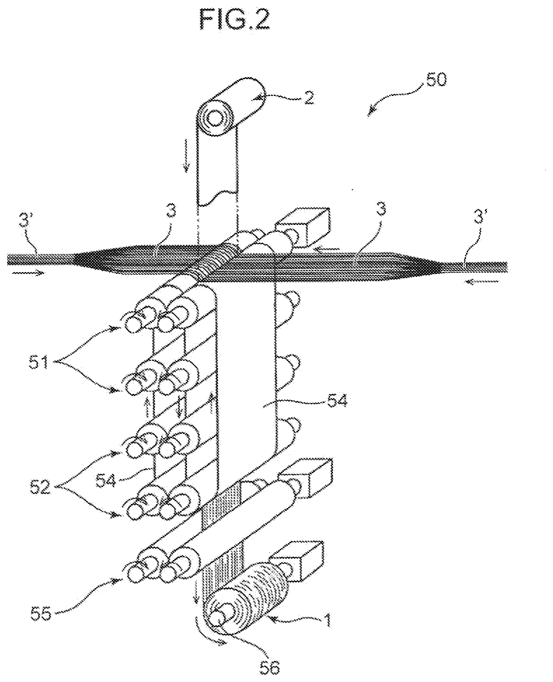

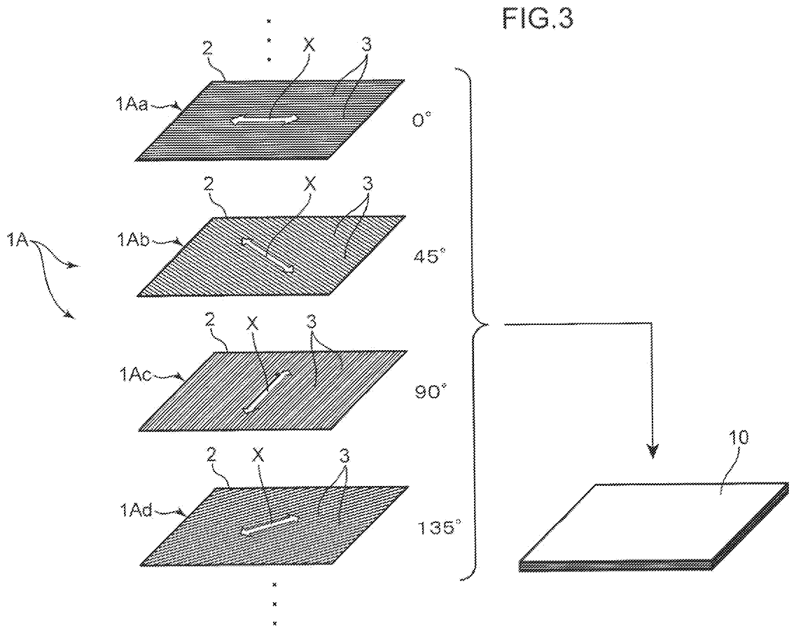

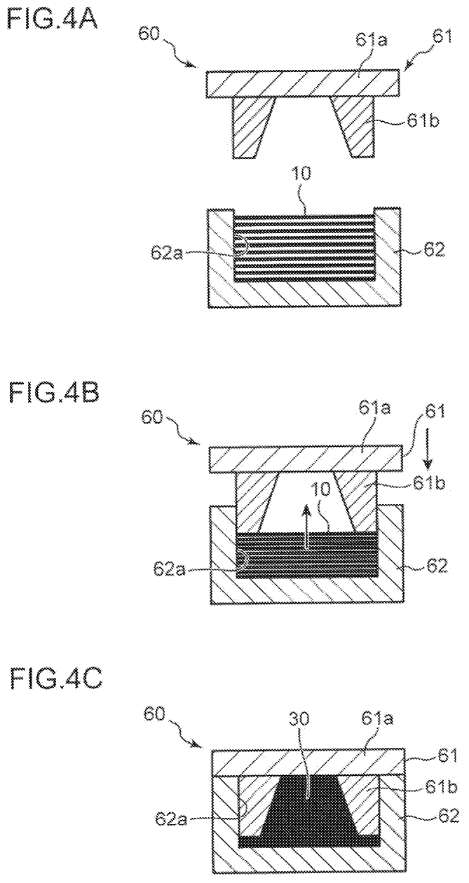

FIG. 1 is a flowchart showing a method for producing a molded article 30 (FIG. 4C) according to a first embodiment of the present invention. In the first embodiment, the molded article 30 is a molded article (composite molded article) made of synthetic resin containing reinforcing fibers, and is produced through Steps (S1 to S3) shown in FIG. 1. Specifically, the molded article 30 of the first embodiment is produced according to a procedure including: Step S1 of preparing a fiber-reinforced resin sheet 1 (FIG. 2); Step S2 of forming a fiber-reinforced composite material 10 (FIG. 3) by stacking the fiber-reinforced resin sheets 1; and Step S3 of pressing the fiber-reinforced composite material 10 to produce the molded article 30 (FIG. 4C). Details of each step are described below.

Preparation of Fiber-Reinforced Resin Sheet

Step S1 is a sheet preparation step of preparing the fiber-reinforced resin sheet 1 shown in FIG. 2. The fiber-reinforced resin sheet 1 prepared in the sheet preparation step S1 is a UD sheet (FRTP sheet) that is a thermoplastic resin film 2 impregnated with a large number of reinforcing fibers 3.

As the reinforcing fiber 3, a carbon fiber, a glass fiber, an aramid fiber, a ceramic fiber, and the like may be used. Among these, the carbon fiber is advantageous in improving the strength, the corrosion resistance and the like of the molded article. As the carbon fiber, a PAN (polyacrylonitrile)-based carbon fiber having a particularly high strength are preferably used.

As the thermoplastic resin being a material of the resin film 2, i.e., as matrix resin for the fiber-reinforced resin sheet 1, polyamide (in particular, PA6, PA9T), polyolefin, polyester, polyacetal, polyphenylene sulfide, polycarbonate, acrylic resin, an acrylnitril-butadien-styrene copolymer (ABS), polyamide-imide, polysulfone, polyphenylsulfone, polyetherimide, polyethersulfone, polyetheretherketone, polyetherketoneketone, polyimide, polyarylate, fluororesin, liquid crystal polymer, thermoplastic epoxy resin, and the like may be raised. In addition, a polymer alloy obtained by mixing two or more kinds of these thermoplastic resins may be used as the material for the resin film 2.

The resin film 2 is a member having the shape of an ultrathin sheet (film shape) having a certain thickness, and is made of the thermoplastic resin. The resin film 2 is prepared, for example, by extruding thermoplastic resin. Further, the thickness of the resin film 2 is set to 5 μm or more and 15 μm or less.

The fiber-reinforced resin sheet 1 can be produced using, for example, a sheet production apparatus 50 shown in FIG. 2. This sheet production apparatus 50 is an apparatus for continuously producing a fiber-reinforced resin sheet 1 from a fiber bundle 3′ being a bundle of reinforcing fibers and a resin film 2 which is thermoplastic.

Specifically, the sheet production apparatus 50 includes a plurality of pairs (two pairs here) of heating rollers 51 arranged vertically, a plurality of pairs (two pairs here) of cooling rollers 522 arranged vertically below the heating rollers 51, a pair of endless belts 54 wound over the heating rollers 51 and the cooling rollers 52, a pair of draw-out rollers 55 located below the endless belts 54, and a winding bobbin 56 arranged below the draw-out rollers 55.

An opening mechanism (not illustrated) for opening and expanding the fiber bundle 3′ in a band shape is provided on both sides of the heating rollers 51 at the uppermost stage. This opening mechanism is capable of forming a large number of continuous reinforcing fibers 3 spread in a thin band shape by continuously opening the fiber bundle 3′. It is sufficient that the opening mechanism has a mechanism capable of performing the operation. Various mechanisms may be used, such as a mechanism that taps the fiber bundle to spread it, a mechanism that blows the fiber bundle to spread it, and a mechanism that applies ultrasonic waves to the fiber bundle to spread it.

In the configuration of FIG. 2, the opening mechanism has a mechanism that supplies the opened reinforcing fibers 3 on one surface of the resin film 2 and a mechanism that supplies the opened reinforcing fibers 3 on the other surface of the resin film 2. The former mechanism is provided so as to introduce the reinforcing fibers 3 between the one surface of the resin film 2 and the heating roller 51 in contact with the one surface, and the latter mechanism is provided so as to introduce the reinforcing fibers 3 between the other surface of the resin film 2 and the heating roller 51 in contact with the other surface.

The heating roller 51 is a high-temperature roller heated by an electric heater, heating medium, or the like. The heating rollers 51 continuously impregnate the resin film 2 with the reinforcing fibers 3 by heating the resin film 2 and the reinforcing fibers 3 introduced onto the both surfaces of the resin film 2 while sandwiching the resin film 2 and the reinforcing fibers 3 from the opposite sides by the endless belts 54. The resin film 2 is impregnated with the reinforcing fibers 3 in a state where the reinforcing fibers 3 are oriented in the same direction (in a vertical direction in FIG. 2).

The cooling roller 52 is a low-temperature roller cooled by cooling medium or the like. The cooling rollers 52 cool the resin film 2 impregnated with the reinforcing fibers 3 while sandwiching the resin film 2 from the opposite sides by the endless belts 54, whereby the reinforcing fibers 3 are embedded in the resin film 2. A fiber-reinforced resin sheet 1, in which the resin film 2 (matrix resin) and the reinforcing fibers 3 are integrated, is thus prepared.

The draw-out roller 55 is a roller that draws out the prepared fiber-reinforced resin sheet 1 downward while applying tension to the fiber-reinforced resin sheet 1.

The winding bobbin 56 is a core material for winding up the fiber-reinforced resin sheet 1. The bobbin 56 is rotationally driven by a drive source such as a motor, and sequentially winds up the fiber-reinforced resin sheet 1 drawn out by the draw-out rollers 55 to form the fiber-reinforced resin sheet 1 into a roll shape.

The fiber-reinforced resin sheet 1 is completed through the above-described steps. A areal weight of the reinforcing fiber 3 in the fiber-reinforced resin sheet 1, i.e., a weight of the reinforcing fibers 3 impregnated per unit area of the resin film 2 is set to 25 g/m² or more and 60 g/m² or less. In other words, the opening mechanism of the sheet production apparatus 50 described above supplies the reinforcing fibers 3 with a predetermined density on the both surfaces of the resin film 2 in such a manner that the areal weight of the reinforcing fibers 3 falls between 25 and 60 g/m². Further, when needed, the target areal weight may be achieved by repeating the above-described sequence of steps (the operation of supplying the reinforcing fibers 3 onto the both surfaces of the resin film 2 to impregnate the resin film 2 with the reinforcing fibers 3) a plurality of times.

The volume content of the reinforcing fibers 3, i.e., a value (Vf value) resulting from dividing a volume occupied by the reinforcing fibers 3 by a volume of the entire fiber-reinforced resin sheet 1 is set to 60% or more and 75% or less. Specifically, the volume content of the reinforcing fibers 3 is set to 60 to 75% by impregnating the resin film 2 having a thickness of 5 to 15 μm with the reinforcing fibers 3 at the above-described areal weight (25 to 60 g/m²).

The fiber-reinforced resin sheet 1 is made to have a thickness of 30 μm or more and 65 μm or less by setting the areal weight and the volume content of the reinforcing fibers within the respective ranges described above. The fiber-reinforced resin sheet 1 having the above thickness has a flexibility high enough to be smoothly formed into a roll shape.

Formation of Fiber-Reinforced Composite Material

After the preparation of the fiber-reinforced resin sheet 1 is completed as described above, the flow proceeds to the subsequent Step S2. Step S2 is a sheet stacking step of forming the fiber-reinforced composite material 10 by stacking the fiber-reinforced resin sheets 1 one over another. In this sheet stacking step S2, as shown in FIG. 3, a plate-shaped fiber-reinforced composite material 10 having a thickness of several millimeters (for example, of 2 mm) is formed by stacking a plurality of base material sheets 1A cut off into a predetermined shape from the fiber-reinforced resin sheet 1 in such a manner that their respective fiber directions X are angularly different from one another in a plan view. Here, the fiber direction X refers to an orientation direction of the reinforcing fibers 3 contained in the base material sheet 1A (fiber-reinforced resin sheet 1).

Specifically, in the sheet stacking step S2, the fiber-reinforced resin sheet 1 (a fiber-reinforced resin sheet 1 having a long length and formed into a roll shape) prepared during the above-described sheet preparation step S1 is cut to thereby make base material sheets 1A having a proper shape and size. Thereafter, the base material sheets 1A having been cut off are stacked in the thickness direction. Here, the base material sheets 1A are stacked in such a manner that the respective fiber directions X of base material sheets 1A adjoining each other in the thickness direction are different from each other. In other words, the base material sheets 1A are stacked in such a manner that the respective fiber directions X of adjoining sheets are angularly different from one another in the plan view.

FIG. 3 shows an example where the base material sheets 1A formed into a rectangular shape are stacked in such a manner that their respective fiber directions X vary from one another at equal increments of 45° in the plan view. Specifically, the base material sheets 1A stacked in the sheet stacking step S2 includes a first base material sheet 1Aa whose fiber direction X is at an angle of 0°, a second base material sheet 1Ab whose fiber direction X is at an angle of 45°, a third base material sheet 1Ac whose fiber direction X is at an angle of 90°, and a fourth base material sheet 1Ad whose fiber direction X is at an angle of 135°.

After having stacked the base material sheets 1A in the manner described above, the base material sheets 1A are heat-fused, for example by heating the base material sheets 1A while pressing them in the thickness direction. A plate-shaped fiber-reinforced composite material 10 in which the base material sheets 1A are integrally stacked is thus formed. The number of the stacked base material sheets 1A is determined in view that the fiber-reinforced composite material 10 has a thickness of roughly several millimeters.

Pressing

After the formation of the fiber-reinforced composite materials 10 is completed as described above, the flow proceeds to the subsequent Step S3. Step S3 is a press step of pressing the fiber-reinforced composite materials 10 using a heat press machine 60 shown in FIGS. 4A to 4C to form a molded article 30 having a predetermined shape.

Specifically, in the press step S3, as shown in FIG. 4A, a plurality of plate-shaped fiber-reinforced composite materials 10 are prepared and are piled inside the mold of the heat press machine 60 in the thickness direction. Each of the fiber-reinforced composite materials 10 is a plate member formed in the stacking step S2 described above, and has a thickness of roughly several millimeters.

As shown in FIG. 4A, the heat press machine 60 includes a punch 61 and a die 62. The die 62 is a mold (female mold) having a recess 62a capable of receiving fiber-reinforced composite materials 10. The punch 61 is a mold (male mold) having a base part 61a and an insertion part 61b that protrudes from a lower surface of the base part 61a. The fiber-reinforced composite materials 10 are arranged in the recess 62a of the die 62 in a state where the materials 10 are piled one over another. The die 62 is provided with a heater (not illustrated) for heating the fiber-reinforced composite materials 10 in the recess 62a to a high temperature.

After the placement of the fiber-reinforced composite materials 10 in the press mold is completed as described above, subsequently, the article 30 is molded by executing a main process (molding) of pressingly inserting the punch 61 into the die 62 while heating the fiber-reinforced composite materials 10. Specifically, the fiber-reinforced composite materials 10 are pressed by pressing the punch 61 downward by a press device not illustrated in a state where the insertion part 61b of the punch 61 is inserted into the recess 62a of the die 62 while heating the die 62 by the heater to thereby raise the temperature of the fiber-reinforced composite materials 10 to a predetermined degree (see FIG. 43). The heating and the pressing soften and deform the fiber-reinforced composite materials 10.

FIG. 4C shows a state in which the punch 61 is pressingly inserted to a stroke end. In this state, the space (i.e., the molding cavity) defined between the punch 61 and the die 62 is filled with the deformed fiber-reinforced composite materials 10. That is, when the fiber-reinforced composite materials 10 are deformed into a shape corresponding to the molding cavity, a molded article 30 made of a fiber-reinforced resin is obtained. After a predetermined cooling period, the molded article 30 is taken out from the die 62 with the punch 61 withdrawn from the die 62.

### Advantageous Effects and the Like

As described above, in the first embodiment of the present invention, the fiber-reinforced composite materials 10 made by stacking a plurality of fiber-reinforced resin sheets 1 (base material sheets 1A) are used as a material for producing the molded article 30, the fiber-reinforced resin sheets 1 each containing reinforcing fibers 3 at a volume content of 60 to 75%. Accordingly, the embodiment has the advantage of producing a molded article 30 having a high strength at a good moldability.

Specifically, in the first embodiment, the fiber-reinforced resin sheet 1 is prepared by placing reinforcing fibers 3 on the both surfaces of a relatively thin resin film 2 of 5 to 15 μm, and the areal weight of the reinforcing fibers 3 to the resin film 2 is set between 25 and 60 g/m². This makes it possible to increase the volume content (Vf value) of reinforcing fibers 3 in the fiber-reinforced resin sheet 1 to 60 to 75% while preventing a formation failure of the sheet 1.

In other words, a configuration where reinforcing fibers 3 are placed on the both surfaces of the resin film 2 enables the areal weight of 25 to 60 g/m² to be achieved over a whole without excessively increasing the placement amount of reinforcing fibers 3 on each surface (one surface or the other surface) of the resin film 2. This makes it possible to sufficiently impregnate each surface of the resin film 2 with reinforcing fibers 3 by the heating and the pressing during the preparation, and increase the bonding strength between the resin film 2 and the reinforcing fibers 3. Further, since the resin film 2 is thin in that the thickness is between 5 and 15 μm, the resin film 2 can be soften by the heating in a shorter time. This makes it possible to sufficiently place reinforcing fibers 3 inside of the resin film 2. This leads to prevention of an occurrence of a failure such as loosening of a reinforcing fiber 3 after the preparation. Additionally, under such conditions, a fiber-reinforced resin sheet 1 with a high volume content (Vf value) of 60 to 75% is realizable. As a result, the strength of a molded article made by using the fiber-reinforced resin sheets 1 (the strength of the fiber-reinforced composite material 10 and the molded article 30 made by using the same) can be sufficiently increased.

In particular, in the first embodiment, when a fiber-reinforced composite material 10 is formed from the fiber-reinforced resin sheets 1, the fiber-reinforced resin sheets 1 are stacked in such a manner that their respective fiber directions X (orientation directions of the reinforcing fibers 3) are angularly different from one another in a plan view. Therefore, the reinforcing effect of the reinforcing fibers 3 can be exerted in a plurality of different directions over the fiber-reinforced composite material 10. Consequently, the mechanical properties of the fiber-reinforced composite material 10 and the molded article 30 can be improved.

In the first embodiment, when a fiber-reinforced composite material 10 is formed from the fiber-reinforced resin sheets 1 (base material sheets 1A), the fiber-reinforced resin sheets 1 are stacked in such a manner that the respective fiber directions X of adjoining sheets are different from one another (for example, the fiber directions X vary at equal increments of 45°). However, the fiber-reinforced resin sheets 1 may be stacked in such a manner that the fiber directions X vary by each group of several sheets.

### (2) Second Embodiment

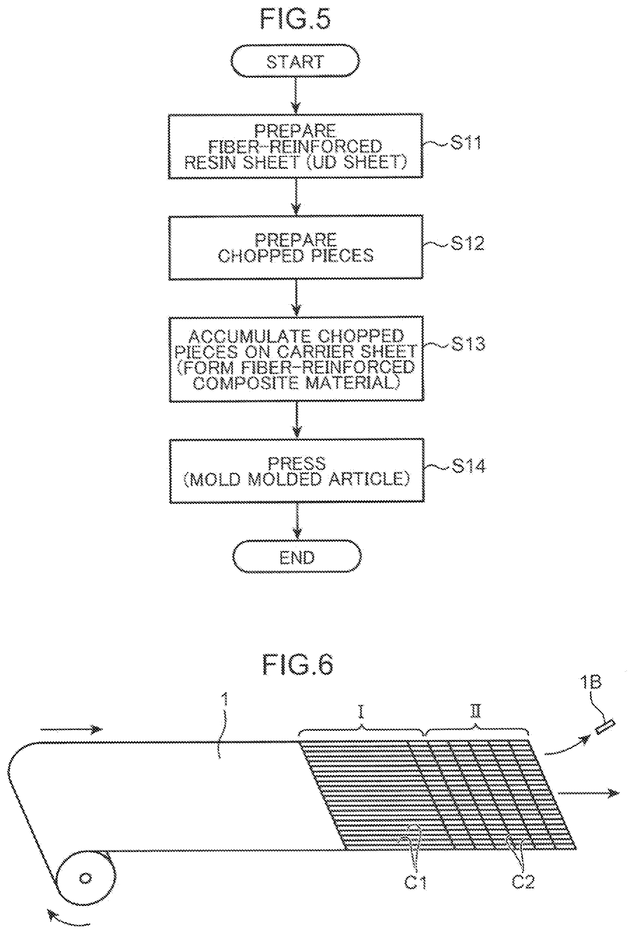

FIG. 5 is a flowchart showing a method for producing a molded article according to a second embodiment of the present invention. The molded article of the second embodiment is a molded article (composite molded article) made of synthetic resin containing reinforcing fibers in the same manner as the molded article 30 of the first embodiment (FIG. 4C) described above, and is produced through Steps (S11 to S14) shown in FIG. 5.

Preparation of Fiber-Reinforced Resin Sheet

Step S11 is a sheet preparation step of preparing the fiber-reinforced resin sheet 1 shown in FIG. 2. Specifically, in this sheet preparation step S11, a UD sheet (an FRTP sheet) containing a thermoplastic resin film 2 and a large number of reinforcing fibers 3 that are placed in the resin film 2 in a state where the reinforcing fibers 3 are arranged in one direction is prepared as the fiber-reinforced resin sheet 1. The resin film 2 has a thickness of 5 to 15 μm and the areal weight of the reinforcing fibers 3 is between 25 and 60 g/m², the volume content of the reinforcing fibers 3 is between 60 and 75%, and the fiber-reinforced resin sheet 1 has a thickness of 30 to 65 μm. The procedure of the sheet preparation step S11 is the same as that of the sheet preparation step S1 in the first embodiment described above, thus detailed description thereof will be omitted.

Preparation of Chopped Pieces

After the preparation of the fiber-reinforced resin sheet 1 is completed as described above, the flow proceeds to the subsequent Step S12. Step S12 is a chopped piece preparation step of cutting off the chopped pieces 1B shown in FIG. 6 from the fiber-reinforced resin sheet 1. In the chopped piece preparation step S12, a large number of chopped pieces 1B having the shape of a rectangle of a predetermined size are prepared by cutting the fiber-reinforced resin sheet 1 in a longitudinal direction and a width direction. Specifically, the chopped pieces 1B are prepared according to the procedure described below.

First, cuts C1 extending in the longitudinal direction are formed as shown in FIG. 6. Specifically, while the fiber-reinforced resin sheet 1 is fed in the longitudinal direction, a large number of longitudinally continuous cuts C1 are formed in a section I in a middle of the feeding path thereof. The cuts C1 may be formed by using a cutting device including a large number of blades arranged at an equal interval in the width direction of the fiber-reinforced resin sheet 1.

Next, in the subsequent section II, cuts C2 which are continuous from an end to the other end of the fiber-reinforced resin sheet 1 in the width direction are formed. The cuts C2 may be formed, for example, using a rotary cutter and the like. The cuts C2 are formed each time the fiber-reinforced resin sheet 1 is fed by a predetermined length in the longitudinal direction. Accordingly, a large number of chopped pieces 1B each having the shape of a rectangle having a shorter side with a length corresponding to a pitch of the cuts C1 and a longer side with a length corresponding to a pitch of the cuts C2 are cut off.

As described above, the fiber-reinforced resin sheet 1 is a thermoplastic resin sheet containing a large number of reinforcing fibers 3 oriented in the longitudinal direction thereof. Therefore, each chopped piece 1B cut off from the fiber-reinforced resin sheet 1 also contains a large number of reinforcing fibers 3 oriented in the longitudinal direction thereof (i.e., in a direction of the longer side thereof). Specifically, the chopped piece 1B contains a resin film 2 which is thermoplastic, and a large number of reinforcing fibers 3 placed in the resin film 2 (matrix resin) in a state of being oriented in the same direction.

The chopped piece 1B is set at a proper size in consideration of the formativeness and the like of the material in the later-described press step (S14). Specifically, the chopped piece 1B is formed in the shape of a rectangle having the shorter side with a length of 2 mm or more and 50 mm or less and the longer side with a length of 2 mm or more and 80 mm or less. As a suitable example, the chopped piece 1B is formed in the shape of a rectangle of 5×20 mm. The chopped pieces 1B have the same thickness as the thickness of the fiber-reinforced resin sheet 1, which is 30 μm or more and 65 μm or less.

Formation of Fiber-Reinforced Composite Material

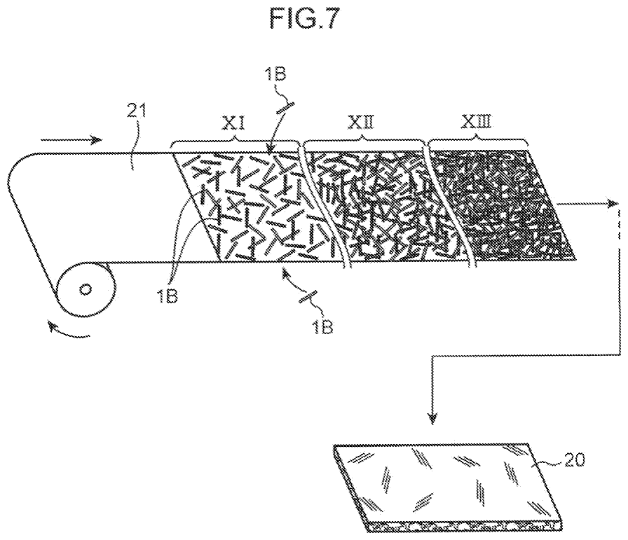

After the preparation of the chopped pieces 1B is completed as described above, the flow proceeds to the subsequent Step S13. Step S13 is a chopped piece placing step of forming a fiber-reinforced composite material 20 shown in FIG. 7 by placing and integrating the chopped pieces 1B with one another. In this chopped piece placing step S13, the fiber-reinforced composite material 20 is formed by placing a large number of chopped pieces 1B in layers over an upper surface of a carrier sheet 21 made of thermoplastic resin two-dimensionally at random and adhering them. Specifically, the fiber-reinforced composite material 20 is formed according to the procedure described below.

First, as shown in FIG. 7, while the carrier sheet 21 is fed in the longitudinal direction thereof, a large number of chopped pieces 1B are dispersed over the upper surface of the carrier sheet 21. This dispersion of the chopped pieces 1B may be performed by using, for example, a dropping device for dropping the chopped pieces 1B from above the carrier sheet 21 with vibration. The dropping operation of the chopped pieces 1B using the dropping device is executed at a plurality of positions in the feeding direction of the carrier sheet 21 to increase the density and layers of the chopped pieces 1B on the carrier sheet 21. Specifically, the dropping operation of the chopped pieces 1B using the dropping device is repeated in a plurality of sections XI, XII, XIII, . . . in the longitudinal direction of the carrier sheet 21, so that a large number of chopped pieces 1B accumulate on the carrier sheet 21 in such a manner that the fiber directions of the reinforcing fibers 3 contained in the chopped pieces 1B (in other words, the longitudinal directions of the chopped pieces 1B) orient in various directions over a horizontal plane, and a plurality of chopped pieces 1B is stacked in the thickness direction.

Next, the carrier sheet 21 and the chopped pieces 1B thereupon are pressed and heated using an unillustrated heating roller, whereby the carrier sheet 21 and the chopped pieces 1B are integrated with one another. Specifically, the carrier sheet 21 and the chopped piece 1B are bonded (fused) with each other, and concurrently, the accumulating chopped pieces 1B are bonded (fused) with each other by the pressing and the heating with the use of the heating roller. The bonding forms a sheet where the carrier sheet 21 and a large number of chopped pieces 1B are integrated. Further, what results from cutting the sheet into proper shape and size is obtained as the fiber-reinforced composite material 20. The thickness of the fiber-reinforced composite material 20, i.e., the total thickness of the carrier sheet 21 and the chopped pieces 1B accumulating thereupon is set at several millimeters (for example, 2 mm). In other words, the layers of the accumulating chopped pieces 1B is set at the number of layers which makes the fiber-reinforced composite material 20 have a thickness of several millimeters.

As the material of the carrier sheet 21, the same thermoplastic resin as the matrix resin (i.e., the resin film 2) of the chopped pieces 1B may be basically used. However, a carrier sheet 21 of various materials may be used as long as the material is a thermoplastic resin, and a carrier sheet 21 of a material different from that of the matrix resin of the chopped pieces 1B may be also used.

FIG. 7 exemplarily shows the case that the fiber-reinforced composite material 20 is formed by placing the chopped pieces 1B only on the upper surface of the carrier sheet 21. However, the chopped pieces 1B may be placed on the both surfaces of the carrier sheet 21. In this case, the process of placing and adhering the chopped pieces 1B on the carrier sheet 21 (i.e., the process of randomly placing the chopped pieces 1B in multi-layers, and pressing and heating them) may be performed on the upper surface and the lower surface of the carrier sheet 21 one after another. Specifically, a fiber-reinforced composite material 20 where the chopped pieces 1B are accumulated on the both surfaces of the carrier sheet 21 can be produced by placing and adhering the chopped pieces 1B on the upper surface of the carrier sheet 21, and thereafter reversing the carrier sheet 21 to face the lower surface of the carrier sheet 21 upward, and repeating the operation of placing and adhering the chopped pieces 1B thereon in that state.

Pressing

After the formation of the fiber-reinforced composite material 20 is completed as described above, the flow proceeds to the subsequent Step S14. Step S14 is a press step of pressing the fiber-reinforced composite material 20 using the heat press machine 60 shown in FIGS. 4A to 4C to form a molded article 30 in a predetermined shape. Since the procedure of this press step S14 is the same as the press step S3 in the first embodiment described above, the detailed description thereof will be omitted.

### Advantageous Effects

As described above, in the second embodiment of the present invention, the fiber-reinforced composite material 20 containing a large number of chopped pieces 1B cutoff from the fiber-reinforced resin sheet 1 and placed one over another is used as a material for producing the molded article 30, the fiber-reinforced resin sheet 1 containing reinforcing fibers 3 at a volume content of 60 to 75%. Accordingly, this embodiment has the advantage of producing a molded article 30 having a high strength at a good moldability in the same manner as the above-described first embodiment.

In particular, in the second embodiment, a large number of chopped pieces 1B cut off into the shape of a rectangle having the shorter side with the length of 2 to 50 mm and the longer side with the length of 2 to 80 mm are prepared. The fiber-reinforced composite material 20 is formed by placing chopped pieces 1B one over another, the fiber directions of the reinforcing fibers 3 contained in the chopped piece 1B being two-dimensionally at random. This makes it possible to impart a sufficient isotropy (pseudo-isotropy) to the mechanical properties of the fiber-reinforced composite material 20. Consequently, a desirable reinforcing effect can be obtained by the reinforcing fibers 3.

In the second embodiment, the fiber-reinforced composite material 20 is formed by placing and adhering a large number of chopped pieces on a carrier sheet 21 made of a thermoplastic resin. However, the carrier sheet 21 may be omitted. In other words, it is also possible to form a composite material made solely of the chopped pieces 1B placed and adhered to one another as the fiber-reinforced composite material 20.

### (3) Examples

Next, Examples of fiber-reinforced resin sheets 1 produced according to the methods described in the first embodiment or the second embodiment (Step S1 of FIG. 1 or Step S11 of FIG. 5) will be described. Examples described hereinafter are fiber-reinforced resin sheets 1 produced under production conditions specified below using the sheet production apparatus 50 shown in FIG. 2.

Production Conditions
Film material: Nylon 9T (PA9T)
Film preparation condition: Extruded in an extrusion temperature of 290 to 310° C.
Roll temperature: 280° C.
Feeding linear speed: 20 m/min

Here, the film material and the film preparation condition mean a material and a preparation condition of the resin film 2. The roll temperature means a temperature of the heating roller 51 of the sheet production apparatus 50. The feeding linear speed means a speed at which the reinforcing fibers 3 are fed to the resin film 2 in the sheet production apparatus 50.

One of the following materials 1 to 3 was used as a reinforcing fiber 3 in preparation of the Examples.

Materials of Reinforcing Fiber
Material 1: 12000 carbon fibers each having a fiber diameter of 7 μm and a fineness of 800 tex
Material 2: 24000 carbon fibers each having a fiber diameter of 5 μm and a fineness of 1030 tex
Material 3: 15000 carbon fibers each having a fiber diameter of 7 μm and a fineness of 1000 tex

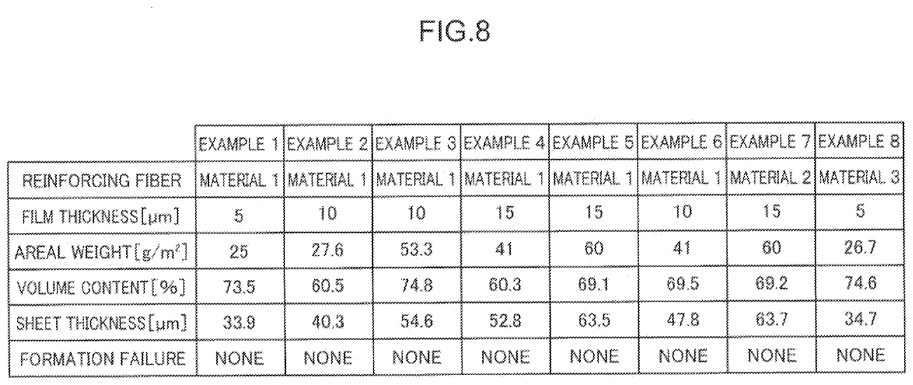

Fiber-reinforced resin sheets 1 were produced using reinforcing fibers 3 of one of the above materials 1 to 3 and under the production conditions described above to thereby obtain Examples 1 to 8 shown in FIG. 8. FIG. 8 shows respective parameters of film thickness, areal weight, volume content, and sheet thickness of Examples 1 to 8. Here, the film thickness means a thickness (μm) of the resin film 2, the areal weight means an areal weight (g/m²) of the reinforcing fibers 3 to the resin film 2, the volume content means a volume content (%) of the reinforcing fibers 3 in the fiber-reinforced resin sheet 1, and the sheet thickness means an actually measured thickness (μm) of the fiber-reinforced resin sheet 1.

As shown in FIG. 8, in Examples 1 to 8, the respective thicknesses of the resin films 2 were within the range of 5 to 15 μm, the respective areal weights of the reinforcing fibers 3 were within the range of 25 to 60 g/m², the respective volume contents of the reinforcing fibers 3 were within the range of 60 to 75%, and the respective thicknesses of the fiber-reinforced resin sheets 1 were within the range of 30 to 65 μm. Hereinafter, these ranges are collectively referred to as the target range.

Here, focusing on a relationship between the resin film 2 and the areal weight of the reinforcing fibers 3, it can be generally said that the two have a relationship that the areal weight of the reinforcing fibers 3 is greater as the resin film 2 is thicker. Specifically, the areal weight in the cases (Examples 2, 3, 6) where the resin film 2 had a thickness of 10 mm was greater on average than the areal weight in the cases (Examples 1, 8) where the thickness was 5 mm, and the areal weight in the cases (Examples 4, 5, 7) where the resin film 2 had a thickness of 15 mm was greater on average than the areal weight in the cases (Examples 2, 3, 6) where the thickness was 10 mm. In this way, the areal weight of the reinforcing fiber 3 was adjusted according to the thickness of the resin film 2. Consequently, the respective volume contents of the reinforcing fibers 3 were kept within the target range (60 to 75%), and the respective thicknesses of the fiber-reinforced resin sheets 1 were also kept within the target range (30 to 65 μm).

FIG. 8 shows a check result as to whether a formation failure occurred or not in each Example together therewith. As shown in FIG. 8, no formation failure was found in any of Examples 1 to 8 (none of the later-described Failures 1 to 3 was found). Specifically, it can be understood that Examples 1 to 8 are excellent as a material for a fiber-reinforced composite material because no formation failure occurred, and the volume content of the reinforcing fibers 3 was high, i.e., 60% or more in Examples 1 to 8.

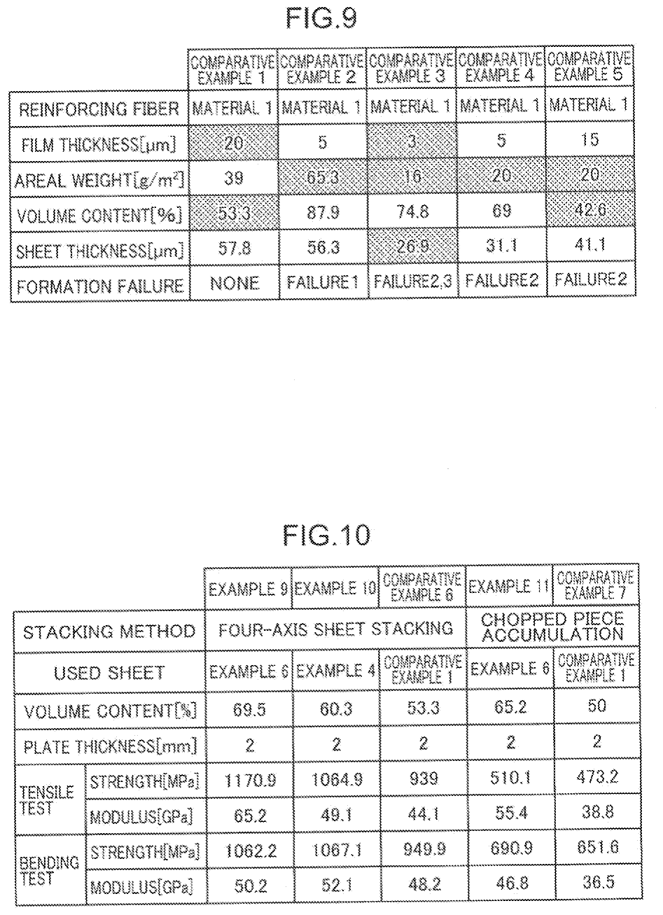

On the other hand, FIG. 9 shows Comparative Examples 1 to 5 including examples having a formation failure or examples having a fiber shortage that the volume content of the reinforcing fibers 3 was less than 60%. Specifically, in Comparative Examples 1 to 5, one or more parameters of the film thickness, the areal weight, the volume content, and the sheet thickness was out of their respective target ranges (numerical values in the grey dotted cells denote parameters out of their respective target ranges). The formation failures (Failures 1 to 3) or fiber shortages occurred due to the deviated parameters. Here, Failure 1 is a failure of causing peeling of reinforcing fibers 3 due to a weak bond between the reinforcing fibers 3 and the resin film 2. Failure 2 is a failure of causing a remarkable deviation of the density of reinforcing fibers 3 in the sheet width direction. Failure 3 is a failure occurring in the resin film 2 itself (the resin film 2 prior to the impregnation of the reinforcing fibers 3).

For example, in Comparative Example 1, the thickness (exceeding 15 μm) of the resin film 2 was greater than the target range although the areal weight of the reinforcing fibers 3 was within the target range. This caused a fiber shortage that the volume content of the reinforcing fibers 3 was less than the target range (60 to 75%). This means that, when a fiber-reinforced composite material is formed using this fiber-reinforced resin sheet 1, the strength of this fiber-reinforced composite material cannot be sufficiently increased.

In Comparative Example 2, the areal weight (exceeding 60 g/m²) of the reinforcing fibers 3 was greater than the target range, which caused Failure 1 causing peeling of reinforcing fibers 3. This is considered to be because the resin content of the resin film 2 was excessively small relative to the content of the reinforcing fibers 3.

In Comparative Example 3, both the thickness of the resin film 2 and the areal weight of the reinforcing fibers 3 were less than the target ranges, which resulted in both Failure 2 causing a remarkable deviation of the fiber density in the width direction and Failure 3 causing a formation failure of the resin film 2. Further, the thickness of the fiber-reinforced resin sheet 1 was out of its target range.

In Comparative Examples 4, 5, the areal weight (less than 60 g/m²) of the reinforcing fibers 3 was less than the target range, which resulted in Failure 2 causing a remarkable deviation of the fiber density in the width direction. Additionally, in Comparative Example 5, a fiber shortage that the volume content of the reinforcing fibers 3 was excessively small (less than 60%) occurred.

It can be paradoxically understood that the parameters should be kept within their respective target ranges in order to sufficiently increase the content of the reinforcing fibers 3 while securing the formability.

Next, Examples and Comparative Examples of fiber-reinforced composite materials will be described. Here, plate-shaped fiber-reinforced composite materials having a thickness of 2 mm were formed using the fiber-reinforced resin sheets 1 of Examples and Comparative Examples described above as Examples 9 to 11 and Comparative Examples 6 and 7. The respective properties are shown in FIG. 10.

Example 9 is a fiber-reinforced composite material 10 obtained by stacking the fiber-reinforced resin sheets 1 of the above-described Example 6 in the above-described method of the first embodiment (FIG. 3). Specifically, a plurality of fiber-reinforced resin sheets 1 of Example 6 were stacked in such a manner that their respective fiber directions X varied from one another at equal angle increments of 45° (four-axis stacking) to form the fiber-reinforced composite material 10 of Example 9, which is a plate-shaped composite material having the thickness of 2 mm.

Example 10 is similar to Example 9 excepting that the sheet to be used as the material was the fiber-reinforced resin sheet 1 of Example 4.

Comparative Example 6 is also similar to Example 9 excepting that the sheet to be used as the material was the fiber-reinforced resin sheet 1 of Comparative Example 1.

Example 11 is a fiber-reinforced composite material 20 obtained by placing the above-described fiber-reinforced resin sheet 1 of Example 6 in the above-described method of the second embodiment (FIG. 7). Specifically, a large number of chopped pieces 1B having the shape of a rectangle (of 5×20 mm here) and being cut off from the fiber-reinforced resin sheets 1 of Example 6 were placed on the upper surface of the carrier sheet 21 to form the fiber-reinforced composite material 20 of Example 11, which is a plate-shaped composite material having the thickness of 2 mm.

Comparative Example 7 is similar to Example 11 excepting that the sheet to be used as the material was the fiber-reinforced resin sheet 1 of Comparative Example 1.

Example 9, Example 10, and Comparative Example 6 are fiber-reinforced composite materials 10 formed using only the respective fiber-reinforced resin sheets 1 as the material. Therefore, the respective volume contents of the reinforcing fibers 3 in the fiber-reinforced composite materials 10 coincided with those of the fiber-reinforced resin sheets 1 (Example 6, Example 4, Comparative Example 1) used as the material. On the other hand, chopped pieces 1B were prepared from the fiber-reinforced resin sheet 1 and placed on a carrier sheet 21 to form the fiber-reinforced composite materials 20 of Example 11 and Comparative Example 7. Therefore, volume contents of the reinforcing fibers 3 in the respective fiber-reinforced composite materials 20 were slightly small relative to those of the fiber-reinforced resin sheets 1 (Example 6, Comparative Example 1) which were materials prior to the formation. This is because the carrier sheet 21 increased the resin content.

A tensile test and a bending test were conducted, and tensile strength, tensile modulus, bending strength, and bending modulus were measured about the above-described Examples 9 to 11 and Comparative Examples 6, 7, respectively. The tensile test was conducted by stretching a test piece having a width of 25 mm, a length of 250 mm, and a thickness of 2 mm in a longitudinal direction thereof. The bending test was conducted by performing a so-called four-point bending test to a test piece having a width of 15 mm, a length of 100 mm, and a thickness of 2 mm. The results of the respective tests are shown in FIG. 10. As shown in this table, the ones (Examples 9, 10, Comparative Example 6) formed in the method of the first embodiment shown in FIG. 3 (four-axis sheet stacking) have higher tensile strength and bending strength than the ones (Example 11, Comparative Example 7) formed in the method of the second embodiment shown in FIG. 7 (chopped piece accumulation). This is considered to be because the former contain reinforcing fibers 3 of a longer length on average than those of the latter. On the other hand, the latter can be said to have the higher isotropy in the mechanical properties because the fiber directions are made sufficiently random although the contained reinforcing fibers 3 are shorter.

Comparing the ones (Examples 9, 10, Comparative Example 6) formed in the method of the first embodiment (four-axis sheet stacking) to one another, Examples 9, 10 show the higher strength (tensile strength, bending strength) and modulus (tensile modulus, bending modulus) than Comparative Example 6. This is considered to be mainly because the volume contents of the reinforcing fibers 3 in Examples 9, 10 are higher than that in Comparative Example 6.

Similarly, comparing the ones (Example 11, Comparative Example 7) formed in the method of the second embodiment (chopped piece accumulation) to one another. Example 11 shows the higher strengths and moduli than Comparative Example 7. This is also considered to be mainly attributable to a difference in the volume contents of the reinforcing fibers 3 from each other.

From the above, it can be understood that the fiber-reinforced composite materials formed using the fiber-reinforced resin sheets of Examples have more excellent mechanical properties than the fiber-reinforced composite materials formed using the liber-reinforced resin sheets of Comparative Examples.

### (4) Summary of Embodiment

The inventions included in the embodiments described above are summarized hereinafter.

A fiber-reinforced resin sheet according to an aspect of the present invention is a fiber-reinforced resin sheet having a thickness of 30 μm or more and 65 μm or less, and contains a resin film which is thermoplastic, and a plurality of reinforcing fibers that are placed on the opposite surfaces of the resin film in a state of being oriented in the same direction after being opened from a bundle of reinforcing fibers, wherein the resin film has a thickness of 5 μm or more and 15 μm or less, an areal weight of the reinforcing fibers is 25 g/m² or more and 60 g/m² or less, and a volume content of the reinforcing fibers is 60% or more and 75% or less.

In this configuration, reinforcing fibers are placed on both surfaces of a relatively thin resin film of 5 to 15 μm to prepare the fiber-reinforced resin sheet, and further, the areal weight of the reinforcing fibers to the resin film is set between 25 and 60 g/m². This makes it possible to increase the volume content of the reinforcing fibers in the fiber-reinforced resin sheet to 60 to 75% while preventing a formation failure of the sheet.

In other words, a configuration where reinforcing fibers are placed on the both surfaces of the resin film enables the achievement of the areal weight of 25 to 60 g/m² over a whole without excessively increasing the placement amount of reinforcing fibers on each surface (one surface or the other surface) of the resin film. This makes it possible to sufficiently impregnate each surface of the resin film with reinforcing fibers by the heating and the pressing during the preparation, and increase the bonding strength between the resin film and the reinforcing fibers. Further, since the resin film is thin in that the thickness is from 5 to 15 μm, the resin film can be softened by the heating in a shorter time. This makes it possible to sufficiently place reinforcing fibers inside of the resin film. This leads to prevention of an occurrence of a failure such as loosening of a reinforcing fiber after the preparation. Additionally, under such conditions, a fiber-reinforced resin sheet with a high volume content of 60 to 75% is realizable. As a result, the strength of a molded article made by using the fiber-reinforced resin sheets can be sufficiently increased.

A fiber-reinforced composite material according to another aspect of the present invention is a fiber-reinforced composite material including the above-described fiber-reinforced resin sheets stacked in a thickness direction, wherein the fiber-reinforced resin sheets are stacked in such a manner that their respective fiber directions that are orientation directions of the reinforcing fibers are angularly different from one another in a plan view.

In this configuration, the reinforcing effect of the reinforcing fibers can be exerted in a plurality of different directions over the fiber-reinforced composite material. Consequently, the mechanical properties of the fiber-reinforced composite material can be improved.

A fiber-reinforced composite material according to a still another aspect of the present invention is a fiber-reinforced composite material including a plurality of chopped pieces that are cut off from the above-described fiber-reinforced resin sheet and are stacked in a thickness direction, wherein the chopped pieces have the shape of a rectangle having a shorter side with a length of 2 mm or more and 50 mm or less and a longer side with a length of 2 mm or more and 80 mm or less, and are stacked in such a manner that their respective fiber directions that are orientation directions of the reinforcing fibers are two-dimensionally at random (Claim 3).

This configuration makes it possible to impart a sufficient isotropy (pseudo-isotropy) to the mechanical properties of the fiber-reinforced composite material. Consequently, a desirable reinforcing effect can be obtained by the reinforcing fibers.

A molded article according to a still another aspect of the present invention is a molded article made by molding the above-described fiber-reinforced composite material.

In this configuration, the strength of a molded article can be sufficiently increased.

1. A fiber-reinforced resin sheet having a thickness of 30 μm or more and 65 μm or less, comprising:
a resin film which is thermoplastic; and
a plurality of reinforcing fibers that are placed on the opposite surfaces of the resin film in a state of being oriented in the same direction after being opened from a bundle of reinforcing fibers, wherein
the resin film has a thickness of 5 μm or more and 15 μm or less,
an areal weight of the reinforcing fibers is 25 g/m² or more and 60 g/m² or less, and
a volume content of the reinforcing fibers is 60% or more and 75% or less.

2. A fiber-reinforced composite material including a plurality of fiber-reinforced resin sheets according to claim 1 stacked in a thickness direction, wherein
the fiber-reinforced resin sheets are stacked in such a manner that their respective fiber directions that are orientation directions of the reinforcing fibers are angularly different from one another in a plan view.

3. A fiber-reinforced composite material including a plurality of chopped pieces that are cut off from the fiber-reinforced resin sheet according to claim 1 and are accumulated in a thickness direction, wherein
the chopped pieces have the shape of a rectangle having a shorter side with a length of 2 mm or more and 50 mm or less and a longer side with a length of 2 mm or more and 80 mm or less, and are accumulated in such a manner that their respective fiber directions that are orientation directions of the reinforcing fibers are two-dimensionally at random.

4. A molded article made by molding the fiber-reinforced composite material according to claim 2.

5. A molded article made by molding the fiber-reinforced composite material according to claim 3.
